(19) United States
(12) Patent Application Publication
(10) Pub. No.: US 2023/0416430 A1
(43) Pub. Date: Dec. 28, 2023

(54) PROCESS FOR MANUFACTURING A FLUOROPOLYMER

(71) Applicant: SOLVAY SPECIALTY POLYMERS ITALY S.P.A, Bollate (Milano ) (IT)

(72) Inventors: Fiorenza D'aprile, 18 Via Alba (IT); Alessio Marrani, Lecco (IT); Eliana leva, Alessandria (IT)

(73) Assignee: SOLVAY SPECIALTY POLYMERS ITALY S.P.A, Bollate (Milano ) (IT)

(21) Appl. No.: 18/254,020

(22) PCT Filed: Nov. 19, 2021
(86) PCT No.: PCT/EP2021/082284

§ 371 Date: May 23, 2023

(30) Foreign Application Priority Data
Nov. 23, 2020 (EP) 20209167.4

(51) Int. Cl. C08F 214/26

(52) U.S. Cl. CPC C08F 214/262

(57) ABSTRACT

The present invention pertains to a surfactant free method for manufacturing a fluoropolymer F comprising, preferably consisting of:
from 45 to 95% by moles of recurring units derived from tetrafluoroethylene (TFE)
from 5 to 35% by moles of recurring units derived from vinylidene fluoride (VDF)
from 0.5 to 20% by moles of one or more perfluoroalkylvinylether (PAVE) of formula (I)

CF₂═CF—O—R_{f} (I)

wherein R_{f} is a C₁-C₆ perfluoroalkyl group and
wherein the molar amounts of said recurring units are relative to the total moles of recurring units in said polymer F.

### TECHNICAL FIELD

This application claims priority to the European Patent Application filed on 23 Nov. 2020 at the EPO with Nr. 20209167.4, the whole content of this application being incorporated herein by reference for all purposes.

The present invention pertains to a process for manufacturing a fluoropolymer, to the fluoropolymer obtainable by said process and to uses of said fluoropolymer in various applications.

### BACKGROUND ART

Fluoropolymers are known in the art which are endowed with both high mechanical resistance and high chemical resistance and which can be melt processed to be suitably used in various applications.

Various attempts have been made in the art to obtain fluoropolymer compositions suitable for use in various applications such as molding, extrusion and coating applications. Copolymers including recurring units derived from tetrafluoroethylene (TFE), vinylidene fluoride (VDF) and perfluorinated alkyl vinyl ethers (PAVE) are known in the art.

Known preparation methods of such copolymers include the use of fluorinated surfactants, such methods are described for example in WO2018/189091 and WO2018/189092 from Solvay Specialty Polymers Italy S.p.A. As well known, the use of fluorinated surfactants in certain applications is restricted for environmental reasons and therefore there is a continued demand for efficient industrial processes to prepare TFE/VDF/PAVE copolymers which do not involve the use of surfactants.

WO 2018/189090 from Solvay Specialty Polymers Italy S.p.A. describes a surfactant free process which allows to prepare latexes of TFE/VDF copolymers and in particular TFE/VDF/PAVE copolymers which can be advantageously used in coating applications. Despite being a surfactant free method, the polymerization process occurs in emulsion and generates a stable latex. Without being bound by theory we believe this is due to the formation of polar terminals from the reaction between VDF monomers and the persulfate initiator. The first oligomers formed produce an effect on the monomers mixture which is comparable to that of a surfactant, allowing to stabilise the emulsion particles while the reaction progresses. The stability of the reaction mixture, and the progress of the reaction is therefore strongly dependent on the amount of VDF monomers, so that this technique is very effective in the production of TFE/VDF/PAVE polymers having a relatively high content of VDF. The example reported in this document uses 40% by moles of VDF, and it is expected that, as the VDF content decreases, the effectiveness of the emulsion reaction also decreases up to the point where, with less than 30% by moles of VDF monomers, the emulsion reaction is no longer possible or efficient in making up the polymer.

There is therefore a need for a surfactant free process to make TFE/VDF/PAVE copolymers in a broader range of VDF content, and in particular for those copolymers having a lower content in VDF which cannot be prepared with the emulsion method of the prior art without the addition of surfactants.

Also there is a need to provide said TFE/VDF/PAVE polymers in a form which is easy to handle and distribute for subsequent applications, such as free flowing particles.

### SUMMARY OF INVENTION

The present invention pertains to a method for manufacturing a fluoropolymer F comprising, preferably consisting of:
from 45 to 95% by moles of recurring units derived from tetrafluoroethylene (TFE)
from 5 to 35% by moles of recurring units derived from vinylidene fluoride (VDF)
from 0.5 to 20% by moles of one or more perfluoroalkylvinylether (PAVE) of formula (I)

CF₂═CF—O—R_{f} (I)

wherein R_{f} is a C₁-C₆ perfluoroalkyl group and
wherein the molar amounts of said recurring units are relative to the total moles of recurring units in said polymer F,
said method being a suspension polymerization method carried out in an aqueous medium in the presence of a radical initiator and without the addition of one or more surfactants, said method being characterized in that
at least a portion of the polymerization reaction, preferably the entire polymerization reaction, is carried out at a temperature comprised between 10 and 130° C., and at a polymerization pressure comprised between 10 and 30 bar
the rate of stirring is such that the Reynolds number Re=ρ·N·d_{I}²/μ, wherein ρ is the density of water (kg/m³), N the number of revolutions per second of the impeller (1/s), d_{I} the diameter of the impeller (m) and p the dynamic viscosity of water (Pas) at the temperature of the reaction, is greater than 3000.

It has been now surprisingly found that the process of the invention advantageously enables to manufacture TFE/VDF/PAVE copolymer (polymer F) directly in the form of free flowing particles which are easy to handle, store and distribute for further applications. The fluoropolymer F of the present invention can be advantageously endowed with a high molecular weight to be suitably used in various applications where outstanding mechanical properties are required, in particular at high temperatures, while having a relatively low viscosity and thus being easily processable in molten phase.

In particular, it has been found that the process of the invention is advantageously carried out in the absence of surfactants. The absence of surfactants in the polymerization process, of reactive fluorinated surfactants in particular, besides the environmental advantages, results in a polymer having improved thermal stability in comparison with polymers obtained by polymerization processes in the presence of reactive surfactants bearing ionic pendant groups.

### DETAILED DESCRIPTION OF THE INVENTION

As mentioned above, the present invention pertains to a method for manufacturing free flowing particles of a fluoropolymer F as defined above. Free flowing particles are desirable in several applications because they do not stick together and therefore can be easily poured from one container to another forming a continuous flow which can be easily controlled, therefore they can be easily transported and dosed precisely for subsequent applications. Also free flowing particles generally do not leave residues in the bottom of storage containers. For the purpose of the present invention polymer particles are defined “free flowing” if they pass the “free flowing test” described in the experimental section.

The fluoropolymer F of the present invention is a copolymer comprising and preferably consisting of recurring units from tetrafluoroethylene (TFE), vinylidene fluoride (VDF), and one or more perfluoroalkylvinyl ethers (PAVE).

More specifically a fluoropolymer F which can be manufactured with the method of the present invention comprises or, preferably, consists of:
from 45 to 95%, preferably from 55 to 85%, more preferably from 60 to 75% by moles of recurring units derived from tetrafluoroethylene (TFE)
from 5 to 35%, preferably from 10 to 35, more preferably from 20 to 29.5% by moles of recurring units derived from vinylidene fluoride (VDF)
from 0.5 to 20%, preferably from 1 to 15%, more preferably from 2 to 8% by moles of one or more perfluoroalkylvinylether (PAVE) of formula (I)

CF₂═CF—O—R_{f} (I)

wherein R_{f} is a C₁-C₆ perfluoroalkyl group.

The molar amounts of said recurring units are relative to the total moles of recurring units in the polymer F.

The perfluoroalkylvinylether (PAVE) of formula (I) is preferably selected

from the group consisting of perfluoromethylvinylether (PMVE) of formula CF₂═CF—O—CF₃, perfluoroethylvinylether (PEVE) of formula CF₂═CF—O—CF₂—CF₃ and perfluoropropylvinylether (PPVE) of formula CF₂═CF—O—CF₂—CF₂—CF₃. Also mixtures of different PAVEs can be used herein.

Even if it is preferred that the polymer F of the invention consists exclusively of recurring units derived from TFE, VDF and PAVE, in a less preferred embodiment the polymer F of the invention may further comprise recurring units derived from one or more additional fluorinated monomers different from TFE, VDF and PAVE. If present, such recurring units derived from one or more fluorinated monomer different from TFE, VDF and PAVE are preferably less than 10% mol, more preferably less than 5% mol, even more preferably less than 1% mol with respect to the total recurring units of the polymer F.

The term “additional fluorinated monomer” in the context of the present invention is intended to denote an ethylenically unsaturated monomer comprising at least one fluorine atom. The choice of this additional fluorinated monomers (when present) is not particularly limited, any fluorinated monomer can be used.

The additional fluorinated monomer may further comprise one or more other halogen atoms (Cl, Br, I) and may be partially or fully halogenated.

Non-limiting examples of additional fluorinated monomers include:
C₃-C₈ perfluoroolefins such as hexafluoropropylene (HFP);
C₂-C₈ hydrogenated fluoroolefins such as vinyl fluoride, 1,2-difluoroethylene and trifluoroethylene;
perfluoroalkylethylenes of formula CH2═CH—R_{f0}, wherein R_{f0} is a C₁-C₆ perfluoroalkyl group;
chloro- and/or bromo- and/or iodo-C₂-C₆ fluoroolefins such as chlorotrifluoroethylene;
partially fluorinated alkylvinylethers of formula CF₂═CFOR_{f1}, wherein R_{f1} is a C₁-C₆ partially fluorinated alkyl group;
CF₂═CFOX₀ (per)fluoro-oxyalkylvinylethers, wherein Xo is a C₁-C₁₂ oxyalkyl group which can be non-fluorinated, partially fluorinated or fully fluorinated, having one or more ether groups, such as perfluoro-2-propoxy-propyl group;
CF₂═CFOCF₂OR_{f2} (per)fluoro-oxyalkylvinylethers, wherein R_{f2} is a C₁-C₆ fluoro- or perfluoroalkyl group, e.g. CF₃, C₂F₅, C₃F₇ or a C₁-C₆ (per)fluorooxyalkyl group having one or more ether groups such as —C₂F₅—O—CF₃;
functional (per)fluoro-oxyalkylvinylethers of formula CF₂═CFOY₀, wherein Y₀ is selected from a C₁-C₁₂ alkyl group or (per)fluoroalkyl group, a C₁-C₁₂ oxyalkyl group, or a C₁-C₁₂ (per)fluorooxyalkyl group, each Y₀ also having one or more ether groups and comprising a carboxylic or sulfonic acid group, in its acid, acid halide or salt form;
bis-olefins of formula R_{A}R_{B}═CR_{C}-T-CR_{D}═R_{E}R_{F}, wherein R_{A}, R_{B}, R_{C}, R_{D}, R_{E} and R_{F}, equal to or different from each other, are selected from the group consisting of H, F, Cl, C₁-C₅ alkyl groups and C₁-C₅ (per)fluoroalkyl groups, and T is a linear or branched C₁-C₁₈ alkylene or cycloalkylene group, optionally comprising one or more ether oxygen atoms, preferably at least partially fluorinated, or a (per)fluoropolyoxyalkylene group, e.g. CH₂═CH—(CF₂)₆—CH═CH₂;
fluorodioxoles, preferably perfluorodioxoles.

The process of the invention is typically conducted in a sealed stainless steel vessel which is sealed and kept under pressure during the polymerization reaction and which is equipped with a mechanical stirrer. An aqueous polymerization medium is introduced in the reactor and may contain initiators and/or chain transfer agents dissolved or dispersed therein. Monomers and the other reactive species are typically fed within the vessel in gas or liquid form, temperature and pressure are typically carefully controlled during the polymerization reaction. It is essential for the method of the present invention that at least a portion and preferably essentially the entire polymerization reaction is carried out at a temperature between 10 and 130° C., preferably between 55 and 85° C. It is also essential for the method of the present invention that at least a portion and preferably essentially the entire polymerization reaction is carried out at a pressure comprised between 10 and 30 bars, preferably between 13 and 28 bars. Within these ranges the skilled person will be able to select the most appropriate temperature and pressure depending on the selection of radical initiator.

As mentioned above the polymerization reaction is conducted in an aqueous medium and is initiated by at least one radical initiator.

While the choice of the radical initiator is not particularly limited, it is understood that, being the reaction conducted in an aqueous medium, water-soluble radical initiators are preferred for initiating and/or accelerating the polymerization. Nevertheless also initiators which are non-soluble in water or which have a poor solubility, can still be used in the present invention because the high level of shear during the reaction is sufficient to create sufficient contact between the reagents to allow the initiator to work.

Both organic and inorganic radical initiators can be used in the process of the present invention. Suitable inorganic radical initiators include, but are not limited to, persulfates such as sodium, potassium and ammonium persulfates and hydrogen peroxide.

Also, organic radical initiators may be used and include, but are not limited to: acetylcyclohexanesulfonyl peroxide; diacetyl peroxydicarbonate; dialkylperoxydicarbonates such as diethylperoxydicarbonate, dicyclohexylperoxydicarbonate, di-2-ethylhexylperoxydicarbonate; tert-butylperoxyneodecanoate; 2,2′-azobis(4-methoxy-2,4-dimethylvaleronitrile; tert-butylperpivalate; dioctanoylperoxide; dilauroyl-peroxide; 2,2′-azobis (2,4-dimethylvaleronitrile); tert-butylazo-2-cyanobutane; dibenzoylperoxide; tert-butyl-per-2ethylhexanoate; tert-butylpermaleate; 2,2′-azobis(isobutyronitrile); bis(tert-butylperoxy)cyclohexane; tert-butyl-peroxyisopropylcarbonate; tert-butylperacetate; 2,2′-bis (tert-butylperoxy)butane; dicumyl peroxide; di-tert-amyl peroxide; di-tert-butyl peroxide (DTBP); p-methane hydroperoxide; pinane hydroperoxide; cumene hydroperoxide; and tert-butyl hydroperoxide.

Other suitable radical initiators notably include halogenated free radical initiators such as chlorocarbon based and fluorocarbon based acyl peroxides such as trichloroacetyl peroxide, bis(perfluoro-2-propoxy propionyl) peroxide, [CF₃CF₂CF₂OCF(CF₃)COO]₂, perfluoropropionyl peroxides, (CF₃CF₂CF₂COO)₂, (CF₃CF₂COO)₂, {(CF₃CF₂CF₂)—[CF(CF₃)CF₂O]ₘ—CF(CF₃)—COO}₂ where m=0-8, [ClCF₂(CF₂)ₙCOO]₂, and [HCF₂(CF₂)ₙCOO]₂ where n=0-8; perfluoroalkyl azo compounds such as perfluoroazoisopropane, [(CF₃)₂CFN═]₂, [symbol] , N=NR [symbol] , where R [symbol] is a linear or branched perfluorocarbon group having 1-8 carbons; stable or hindered perfluoroalkane radicals such as hexafluoropropylene trimer radical, [(CF₃)₂CF]₂(CF₂CF₂)C radical and perfluoroalkanes.

Redox systems, comprising at least two components forming a redox couple, such as oxalate-permanganate, dimethylaniline-benzoyl peroxide, diethylaniline-benzoyl peroxide and diphenylamine-benzoyl peroxide may also be used as radical initiators in the present invention.

Among inorganic radical initiators particularly preferred are inorganic persulfates and in particular, potassium and/or ammonium persulfate.

Among organic radical initiators, peroxides having a self-accelerating decomposition temperature (SADT) higher than 50° C. are particularly preferred, such as for instance: di-tert-butyl peroxide (DTBP), diterbutylperoxyisopropylcarbonate, terbutyl(2-ethyl-hexyl)peroxycarbonate, terbutylperoxy-3,5,5-trimethylhexanoate.

One or more radical initiators as defined above may be added to the aqueous polymerization medium of the process of the invention in a total amount ranging advantageously from 0.001% to 20% by weight based on the weight of the aqueous polymerization medium.

Typically a small amount of initiator is introduced in the reactor at the beginning of the polymerization process, in order to get it started, and subsequently an additional amount of initiator is added continuously or stepwise to the reactor until the polymerization reaction is complete.

The process of the invention is preferably carried out in the presence of at least one chain transfer agent.

The chain transfer agent is generally selected from those known in the polymerization of fluorinated monomers such as ethane, ketones, esters, ethers or aliphatic alcohols having from 1 to 10 carbon atoms like, e.g., acetone, ethylacetate, diethylether, methyl-ter-butyl ether, isopropyl alcohol; chloro(fluoro)carbons, optionally containing hydrogen, having from 1 to 6 carbon atoms, like, e.g., chloroform, trichlorofluoromethane; bis(alkyl)carbonates wherein the alkyl has from 1 to 5 carbon atoms like, e.g., bis(ethyl)carbonate, bis(isobutyl)carbonate. The chain transfer agent may be fed to the aqueous medium at the beginning, continuously or in discrete amounts (step-wise) during the polymerization, continuous or stepwise feeding being preferred.

Another essential feature of the process of the invention is that no surfactant is added in the process of the invention.

Another essential technical feature of the process of the invention is that the polymerization reaction is carried out under a particularly high shear stirring. A high shear is very important because it allows the various reagents which can be in different physical states or not miscible to come into contact and react. In fact TFE and VDF monomers are gaseous at the polymerization condition, PAVE mat be liquids, depending on the chain length. The polymerization medium is aqueous and in general the monomers will not be solubilized in a water based medium due to their polarity, while initiators and the optional chain transfer agents may be dissolved in said aqueous medium. In the absence of surfactants and/or of a sufficient amount of VDF such that the reaction can occur in emulsion, it is very difficult to carry out this polymerization reaction in normal polymerization conditions. The applicant have surprisingly found that if the reagents are brought in contact at the required polymerization conditions, the polymerization reaction carries out efficiently as a suspension polymerization only when the polymerization medium is subject to a particularly high shear stirring.

In polymerization reactors suitable for the present invention shear is typically imparted by a stirrer with an impeller. Typically, the diameter of the vessel is chosen such that is does not exceed 2 to 4 times the diameter of the impeller. The geometry of the reactor and of the stirrer can vary greatly, and so can the stirring speed which can be imparted. In order to reach sufficient shear stirring

For “particularly high shear stirring” in the present application it is intended a rate of stirring such that the Reynolds number is greater than 3000, preferably greater than 3500, more preferably greater than 3700, even more preferably greater than 3900.

As known to the skilled person the Reynolds number is a dimensionless parameter which is the ratio of inertial forces to viscous forces within a fluid which is subjected to relative internal movement due to different fluid velocities.

In general low Reynolds numbers correspond to laminar flow, where viscous forces are dominant, and is characterized by smooth, constant fluid motion, while high Reynolds numbers correspond to turbulent flow which is dominated by inertial forces and tend to produce chaotic eddies, vortices and other flow instabilities.

The Reynolds number (Re) is calculated from the following formula:

Re=ρ·N·d_{I}²/μ
wherein:
ρ is the density of water (kg/m³),
N the number of revolutions per second of the impeller (1/s),
d_{I} the diameter of the impeller (m) and
μ the dynamic viscosity of water at the set temperature (Pa·s).

In a preferred embodiment, the process of the invention includes a further step wherein, after the completion of the polymerization reaction, the polymer F is unloaded from the reactor. Due to the specific process steps utilized, and differently from the prior art where the polymer was discharged as a latex, the result of the polymerization process according to the invention is a polymer F in the form of larger particles (if compared with the particles making up the latex of the prior art) which, in absence of agitation, do not remain dispersed within the polymerization medium but rather tend to settle at the bottom of the vessel. The particles of polymer F unloaded from the reactor are typically filtered to remove the residual polymerization medium and, preferably, washed with demineralized water to further remove residues deriving from the polymerization medium. The particles are then dried using conventional methods e.g. heating them at 160° C. for 16 hours.

Surprisingly the particles of polymer F thus obtained have a free flowing behaviour and pass the “free flowing test” described below.

The polymer F in the form of free flowing particles can be easily stored, handled and transported for commercialization or further processing.

The particles of polymer F are typically melt-processable. The term “melt-processable” is hereby intended to denote a fluoropolymer which can be processed by conventional melt-processing techniques.

The polymer F of the invention typically has a melting point (Tₘ) comprised between 170° C. and 300° C., preferably between 190° C. and 280° C.

In another aspect the present invention relates to Fluoropolymer particles obtainable from the method described above. These particles consisting essentially of a fluoropolymer F which comprises and preferably consists of:
from 45 to 95%, preferably from 55 to 85%, more preferably from 60 to 75% by moles of recurring units derived from tetrafluoroethylene (TFE)
from 5 to 35%, preferably from 10 to 35%, more preferably from 20 to 29.5% by moles of recurring units derived from vinylidene fluoride (VDF)
from 0.5 to 20%, preferably from 1 to 15%, preferably from 2 to 8% by moles of one or more perfluoroalkylvinylether (PAVE) of formula (I)

CF₂═CF—O—R_{f} (I)

wherein R_{f} is a C₁-C₆ perfluoroalkyl group and wherein the molar amounts of said recurring units are relative to the total moles of recurring units in said polymer. Preferably the PAVE is selected from the group consisting of perfluoromethylvinylether (PMVE) of formula CF₂═CF—O—CF₃, perfluoroethylvinylether (PEVE) of formula CF₂═CF—O—CF₂—CF₃ and perfluoropropylvinylether (PPVE) of formula CF₂═CF—O—CF₂—CF₂—CF₃ and mixtures thereof.

The fluoropolymer particles of the invention are free flowing particles in accordance with the “free flowing test” described below in the experimental section and preferably have an weight average D50 particle size of from 4 to 80 μm, more preferably from 6 to 70 μm.

The fluoropolymer particles of the invention, being manufactured using a surfactant free method, are free from surfactants, even in traces amounts.

In a further instance, the present invention pertains to use of the free flowing particles of polymer F in various applications.

In particular, free flowing particles of polymer F of the invention are particularly suitable for melt compounding e.g. in an extruder and for molding e.g. injection molding (as pure material or in blend with other polymers) to form e.g. films, pipes and molded parts. Also the free flowing particles of the invention can find application in coatings.

Should the disclosure of any patents, patent applications, and publications which are incorporated herein by reference conflict with the description of the present application to the extent that it may render a term unclear, the present description shall take precedence.

The invention will be now described in more detail with reference to the following examples whose purpose is merely illustrative and not limitative of the scope of the invention.

Test Methods

Measurement of the Second Melting Temperature The melting point was determined by differential scanning calorimetry (DSC) according to ASTM D 3418 standard method. The endothermic peak observed during the first heating was integrated to obtain the melt enthalpy DH of the polymer. The second melting temperature, defined as the maximum of the endothermic peak observed during the second heating period, was recorded and is hereby referred to as the melting point (Tₘ) of the polymer.

Determination of D50 Particle Size

The average particles size of the free flowing particles obtained with the method of the present invention has been determined as D50 particle size (by weight). As known to the skilled person the “D50”, based on the weight of a sample of particles, indicates the size in microns wherein 50% by weight of the particles have a size which is lower than D50. For the purpose of the present invention D50 was measured using a sieving method. The equipment used was equipped with screens from International Endecotts, in the range from 74 to 1000 μm, diameter 220 mm, metallic wire, using a 50 g sample size dried and conditioned at room temperature.

Free Flowing Particles Test

According to the present invention, particles of polymers are considered “free flowing” if they pass the free flowing test.

Test procedure: 15 g of polymer particles are introduced into a perfectly dry class A 25 ml cylinder resting on a horizontal surface. The cylinder is then quickly inclined so to pour off the particles at an angle of 30° with respect to the ground, the cylinder is kept in this inclined position for 5 seconds, after which is placed back on the horizontal surface. The particles are considered free flowing if at the end of the test no more than 0.25 grams of residual particles are be present in the cylinder.

Manufacture of Polymer F as Free Flowing Particles.

Example 1 (Terpolymer TFE 68 mol % NDF28 mol %/MVE 4 mol %). In an AISI 316 steel 5 litre vertical autoclave, equipped with baffles and a stirrer working at 650 rpm (corresponding to a Reynolds number of 4000), 3.5 litre of demineralized water were introduced. The temperature was then brought to reaction temperature of 65° C. and, when this temperature was reached, 0.3 bar of perfluorinated methylvinylether (MVE) were introduced.

A gaseous mixture of TFE-VDF-MVE in the molar nominal ratio of 68:28:4 was subsequently added via a compressor until reaching a total pressure of 20 bar.

Then, 10 ml of a 3% by weight water solution of ammonium persulfate (APS) as initiator was fed. The polymerization pressure was maintained constant by feeding the above mentioned TFE-VDF-MVE mixture. At the same time also the APS solution was continuously fed. When 500 g of the gaseous mixture and a total of 50 ml of APS solution were fed, the reactor was cooled at room temperature, the polymer was discharged in particulate form and then washed with demineralized water and dried at 160° C. for 16 hours.

### Example 2 (Tetrapolymer TFE 67.8 mol % NDF 27.8 mol %/MVE 3.9 mol %/PVE 0.5 mol %)

In an AISI 316 steel 5 liter vertical autoclave, equipped with baffles and a stirrer working at 650 rpm (corresponding to a Reynolds number of 4000), 3.5 liter of demineralized water were introduced. The temperature was then brought to reaction temperature of 65° C. and, when this temperature was reached, 0.4 bar of Ethane (chain transfer agent) and 5 ml of liquid perfluorinated propylvinylether (PVE) were introduced.

A gaseous mixture of TFE-VDF-MVE in the molar nominal ratio of 68:28:4 was subsequently added via a compressor until reaching a total pressure of 20 bar.

Then, 10 ml of a 3% by weight water solution of ammonium persulfate (APS) as initiator was fed. The polymerization pressure was maintained constant by feeding the above mentioned TFE-VDF-MVE mixture. At the same time also the APS solution was continuously fed and 5 ml of PVE were also loaded in the reactor for every 150 grams of gaseous mixture TFE-VDF-MVE introduced. When 500 g of the gaseous mixture, a total of of APS solution and a total of and 15 ml of PVE were fed, the reactor was cooled at room temperature, the polymer was discharged washed and dried as the polymer of example 1.

### Example 3

The same procedure was followed as for Example 2 except that instead of Ethane, Ethyl Acetate was used as chain transfer agent, introduced as a liquid in an amount of 25 ml, and the total amount of APS solution introduced was 100 ml instead of 60 ml.

### Example 4

The same procedure was followed as for Example 2 except that instead of Ethane, Ethyl Acetate was used as chain transfer agent, introduced as a liquid in an amount of 10 ml, and the total amount of APS solution introduced was 80 ml instead of 60 ml.

### Example 5

The same procedure was followed as for Example 2 except that instead of Ethane, Ethyl Acetate was used as chain transfer agent, introduced as a liquid in an amount of 2 ml, and the initial amount of APS solution introduced was 15 ml (instead of 10 ml) and the total amount of APS solution introduced was 135 ml (instead of 60 ml).

### Comparative Example 1

The same procedure of example 1 was followed with the exception of the following conditions:
monomer feed composition TFE/VDF/MVE 58/38/4
stirrer speed corresponding to a Reynolds number of 2700
T 80° C.
pressure 12 bar

At the end of polymerization the polymer was unloaded from the reactor in the form of a latex. The latex was then frozen for 48 hours and, once unfrozen, the coagulated polymer was washed with demineralized water and dried at 160° C. for 16 hours. The resulting material is an heterogeneous coarse powder (D50 840 μm) which is not free flowing.

### Comparative Example 2

The same procedure of example 1 was followed with the exception of the following conditions:
stirrer speed (corresponding to a Reynolds number of 2700)

At these conditions the polymerization does not progress effectively.

TABLE I
Physical properties of the polymers

| | Tm2 (° C.) | MFI (300° C., 5 kg) | Particle size D50 (μm) |
|---|---|---|---|
| Ex. 1 | 219 | No flow | 15 |
| Ex. 2 | 209 | 0.38 | 10 |
| Ex. 4 | 198 | >300 | 11 |
| Ex. 5 | 207 | 115 | 7 |
| Ex. 6 | 220 | 2.2 | 62 |
| Comp. 1 | 222 | <5 | 840 |
| Comp. 2 | — | — | — |

1. A method for manufacturing a fluoropolymer F comprising:
from 45 to 95% by moles of recurring units derived from tetrafluoroethylene (TFE)
from 5 to 35% by moles of recurring units derived from vinylidene fluoride (VDF)
from 0.5 to 20% by moles of one or more perfluoroalkylvinylether (PAVE) of formula (I)
CF₂═CF—O—R_{f} (I)
wherein R_{f} is a C₁-C₆ perfluoroalkyl group and
wherein the molar amounts of said recurring units are relative to the total moles of recurring units in the fluoropolymer F,
said method being a suspension polymerization reaction carried out in an aqueous medium in the presence of a radical initiator and without the addition of one or more surfactants, said method being characterized in that
at least a portion of the suspension polymerization reaction is carried out at a temperature comprised between 10 and 130° C., and at a polymerization pressure comprised between 10 and 30 bar
a rate of stirring is such that the Reynolds number Re=ρ·N·d_{I}²/μ, wherein ρ is the density of water (kg/m³), N the number of revolutions per second of the impeller (1/s), dr the diameter of the impeller (m) and μ the dynamic viscosity of water (Pa·s) at the temperature of the reaction, is greater than 3000.

2. The method of claim 1 wherein the rate of stirring is such that the Reynolds number, is greater than 3500.

3. The method of claim 1 further comprising the following steps:
after the completion of the suspension polymerization reaction, the fluoropolymer F is unloaded from a reactor in the form of polymer particles,
said polymer particles are washed with demineralized water and then dried thereby providing particles of the fluoropolymer F which are free flowing according to the “free flowing test” described herein.

4. The method of claim 1 wherein said PAVE is selected from the group consisting of perfluoromethylvinylether (PMVE) of formula CF₂═CF—O—CF₃, perfluoroethylvinylether (PEVE) of formula CF₂═CF—O—CF₂—CF₃ and perfluoropropylvinylether (PPVE) of formula CF₂═CF—O—CF₂—CF₂—CF₃ and mixtures thereof.

5. The method of claim 1 wherein said fluoropolymer F comprises:
from 55 to 85% by moles of recurring units derived from tetrafluoroethylene (TFE)
from 10 to 35% by moles of recurring units derived from vinylidene fluoride (VDF)
from 1 to 15% by moles of one or more perfluoroalkylvinylether (PAVE) of formula (I).

6. The method of claim 1 wherein the radical initiator is selected from inorganic persulfates.

7. The method of claim 1, wherein said fluoropolymer F further comprises recurring units derived from one or more additional fluorinated monomer different from TFE, VDF and PAVE.

8. The method according to claim 7, wherein said additional fluorinated monomer is present in an amount of less than 10% mol with respect to the total recurring units of the fluoropolymer F.

9. The method of claim 1 wherein the temperature is comprised between 55 and 85° C. and the pressure is comprised between 13 and 28 bars.

10. Fluoropolymer particles obtained from the method of claim 1, said particles consisting essentially of a fluoropolymer F comprising:
from 45 to 95% by moles of recurring units derived from tetrafluoroethylene (TFE)
from 5 to 35% by moles of recurring units derived from vinylidene fluoride (VDF)
from 0.5 to 20% by moles of one or more perfluoroalkylvinylether (PAVE) of formula (I)
CF₂═CF—O—R_{f} (I)
wherein R_{f} is a C₁-C₆ perfluoroalkyl group and
wherein the molar amounts of said recurring units are relative to the total moles of recurring units in said fluoropolymer,
said fluoropolymer particles being characterized by being free flowing particles in accordance with the “free flowing test” described herein.

11. Fluoropolymer particles according to claim 10 wherein said fluoropolymer F comprises:
from 55 to 85% by moles of recurring units derived from tetrafluoroethylene (TFE)
from 10 to 35% by moles of recurring units derived from vinylidene fluoride (VDF)
from 1 to 15% by moles of one or more perfluoroalkylvinylether (PAVE) of formula (I).

12. Fluoropolymer particles according to claim 10 wherein said PAVE is selected from the group consisting of perfluoromethylvinylether (PMVE) of formula CF₂═CF—O—CF₃, perfluoroethylvinylether (PEVE) of formula CF₂═CF—O—CF₂—CF₃ and perfluoropropylvinylether (PPVE) of formula CF₂═CF—O—CF₂—CF₂—CF₃ and mixtures thereof.

13. Fluoropolymer particles according to claim 10 wherein said particles have an average size D50 of from 4 to 80 μm.

14. Fluoropolymer particles according to claim 10 further characterized by being free of surfactants.

15. A method comprising: manufacturing molded or extruded articles with fluoropolymer particles according to claim 10.

16. The method of claim 1, wherein the fluoropolymer F consists of:
from 45 to 95% by moles of recurring units derived from tetrafluoroethylene (TFE)
from 5 to 35% by moles of recurring units derived from vinylidene fluoride (VDF)
from 0.5 to 20% by moles of one or more perfluoroalkylvinylether (PAVE) of formula (I).

17. The method of claim 1, wherein the entire suspension polymerization relation is carried out at the temperature comprised between 10 and 130° C., and at the polymerization pressure comprised between 10 and 30 bar.

18. Fluoropolymer particles according to claim 10, wherein the fluoropolymer F consists of:
from 45 to 95% by moles of recurring units derived from tetrafluoroethylene (TFE)
from 5 to 35% by moles of recurring units derived from vinylidene fluoride (VDF)
from 0.5 to 20% by moles of one or more perfluoroalkylvinylether (PAVE) of formula (I).
